(19) United States
(12) Patent Application Publication
(10) Pub. No.: US 2011/0189251 A1
(43) Pub. Date: Aug. 4, 2011

(54) COMPOUNDS AND COMPOSITIONS FOR THE CONTROL OF PESTS

(76) Inventors: R. Michael Roe, Middlesex, NC (US); Allen L. Jones, JR., Pittsboro, NC (US)

(21) Appl. No.: 12/665,966

(22) PCT Filed: Jun. 24, 2008
(86) PCT No.: PCT/US08/07826

§ 371 Date: Apr. 21, 2011

Related U.S. Application Data
(60) Provisional application No. 60/946,046, filed on Jun. 25, 2007.

(51) Int. Cl. A01N 25/00; A01N 35/02; A01P 7/00; A01P 7/04; A01P 7/02

(52) U.S. Cl. 424/413; 514/675; 424/84

(57) ABSTRACT

A method of killing a pest such as an arthropod or invertebrate pest comprises contacting an active agent such as 2-undecanone to said pest in an amount effective to kill said pest. In some embodiments, the contacting step is carried out by applying the active agent such as 2-undecanone or composition containing the same to a plant or animal (e.g., a human, or other mammalian species such as dog, cat, horse, pig, cow sheep, goat, etc.) in an amount substantially non-toxic to said plant or animal. In some embodiments, the contacting step is carried out by applying said active agent such as 2-undecanone as a composition (e.g., an aqueous composition) comprising said 2-undecanone in combination with a soy methyl ester. The composition may be in the form of an emulsion (including microemulsions).

### FIELD OF THE INVENTION

The present invention concerns compounds, compositions and methods for the control of pests such as insects and mites.

### BACKGROUND OF THE INVENTION

The following references are noted herein:

M. Roe, Method of repelling insects, U.S. Pat. Nos. 6,437,001 and 6,800,662;

M. Roe, Method of repelling insects, US Patent Application Publication No. 20040242703;

A. Jones, Pest-combating compositions comprising soy methyl ester, US Patent Application Publication No. 2006/0127434 (Jun. 15, 2006); and

A Jones, Pest control compositions, and methods and products utilizing same, PCT Application WO 2006/065886

### SUMMARY OF THE INVENTION

A first aspect of the invention is a method of killing a pest such as an arthropod or invertebrate pest, comprising contacting an active agent such as 2-undecanone (or other active agent as described below) to said pest in an amount effective to kill said pest.

In some embodiments, the contacting step is carried out by applying the active agent such as 2-undecanone or composition containing the same to a plant or animal (e.g., a human, or other mammalian species such as dog, cat, horse, pig, cow, sheep, goat, etc.) in an amount substantially non-toxic to said plant or animal.

In some embodiments, the contacting step is carried out by applying said active agent such as 2-undecanone as a composition (e.g., an aqueous composition) comprising said 2-undecanone in combination with a soy methyl ester. The composition may be in the form of an emulsion (including microemulsions).

A further aspect of the present invention is the use of an active agent (such as 2-undecanone) as described herein for the preparation of a composition for carrying out a method of killing an arthropod pest as described herein.

### BRIEF DESCRIPTION OF THE DRAWINGS

FIG. 1. One week growth (cm) of bean plants treated with BioUD 4% (2-undecanone).

FIG. 2. Fresh weight (gr) of two-week old bean plants treated with BioUD 4% (2-undecanone).

FIG. 3. One week growth (cm) of bean plants treated with BioUD 4% (2-undecanone).

FIG. 4. Fresh weight (gr) of two-week old bean plants treated with BioUD 4% (2-undecanone).

FIG. 5. Percentage mortality of adult tobacco aphids exposed to different 2-undecanone concentrations, using BioUD 4% formulated with silicone.

FIG. 6. Mean and standard deviation for time to kill in four insecticidal treatments on German cockroaches. Letters depict statistically significant differences (ANOVA) at the 5% level (however, doses are not comparable between adults and nymphs, because different Volumes (10 and 5 μL) were used and weights were not taken).

FIG. 7. Percent repellency (±SEM) of soy methyl ester against 10, 20, and 30 days old cockroach nymphs (Blattella germanica).

FIG. 8. Killing activity on termites.

The present invention is explained in greater detail below. The disclosures of all United States Patent references cited herein are to be incorporated by reference herein in their entirety.

### DETAILED DESCRIPTION OF THE PREFERRED EMBODIMENTS

Active agents. Active agents, including compositions thereof, that can be used to carry out the present invention typically comprise undecanone (particularly 2-undecanone, but also other compounds of the general formula RC(═O)CH₃ where R is C4-C20 linear or branched alkyl), as described in M. Roe, Method of repelling insects, U.S. Pat. Nos. 6,437,001 and 6,800,662 and M. Roe, Method of repelling insects, US Patent Application Publication No. 2004/0242703.

Compositions. The active agents as described herein can be formulated in a variety of ways, including but not limited to those described in U.S. Pat. No. 6,048,892, to be used as an active ingredient of a pesticide is usually formulated by mixing with a solid carrier, a liquid carrier, a gaseous carrier or bait, or is impregnated with a base material of a mosquito-coil or mosquito-mat for electric heating fumigation.

A surfactant, a sticking agent, a dispersion agent, a stabilizer and other auxiliaries or additives are added if necessary.

Examples of the formulations for the present compound include oil solutions, emulsifiable concentrates, wettable powders, flowable formulations, granules, dusts, aerosols, combustible or chemical fumigants such as mosquito-coil, mosquito-mats for electric heating fumigation and a porous ceramic fumigant, volatile formulation applied on resin or paper, fogging formulation, ULV formulation (formulations for ultra low volume application) and poisonous bait.

These formulations include the present compound as an active ingredient in an amount of 0.001% to 95% by weight.

Examples of the solid carrier to be used for the formulation include fine powder or granules of clays (e.g. kaolin clay, diatomaceous earth, synthetic hydrated silicon oxide, bentonite, Fubasami clay, acid clay), talc, ceramics, other inorganic minerals (e.g. sericite, quartz, sulfur, active carbon, calcium carbonate, hydrated silicon oxide) and chemical fertilizers (e.g. ammonium sulfate, ammonium phosphate, ammonium nitrate, ammonium chloride and urea).

Examples of the liquid carrier to be used for the formulation include water, alcohols such as methanol and ethanol, ketones such as acetone and methyl ethyl ketone, aromatic hydrocarbons such as benzene, toluene, xylene, ethylbenzene and methylnaphthalene, aliphatic hydrocarbons such as hexane, cyclohexane, kerosine and gas oil, esters such as ethyl acetate and butyl acetate, nitrites such as acetonitrile and isobutyronitrile, ethers such as diisopropyl ether and dioxane, acid amides such as N,N-dimethylformamide and N,N-dimethylacetamide, halogenated hydrocarbons such as dichloromethane, trichloroethane and carbon tetrachloride, dimethyl sulfoxide, vegetable oils such as soybean oil and cottonseed oil.

Examples of the gaseous carrier or propellant to be used for the formulation include chlorofluorocarbons, butane gas, LPG (liquefied petroleum gas), dimethyl ether and carbon dioxide.

Examples of the surfactant include alkyl sulfates, alkylsulfonates, alkylarylsulfonates, alkyl aryl ethers, polyoxyethylenealkyl aryl ethers, polyethylene glycol ethers, polyhydric alcohol ethers and sugar alcohol derivatives.

Examples of the sticking agents, the dispersing agent, and other auxiliaries or additives include casein, gelatin, polysaccharides such as starch, gum arabic, cellulose derivatives and alginic acid, lignin derivatives, bentonite, sugars and synthetic water-soluble polymers such as polyvinyl alcohol, polyvinylpyrrolidone and polyacrylic acid.

Examples of the stabilizer include PAP (acid isopropyl phosphate), BHT (2,6-di-tert-butyl-4-methyphenol), BHA (mixture of 2-tert-butyl-4-methoxyphenol and 3-tert-butyl-4-methoxyphenol), vegetable oils, mineral oils, surfactants, fatty acids and esters of fatty acid.

The base material of the mosquito-coil may be a mixture of raw plant powder such as wood powder and Pyrethrum marc and a binding agent like Tabu powder (powder of Machilus thunbergii), starch or gluten.

The base material of the mosquito-mat for electric heating fumigation may be a plate of compacted fibrils of cotton linters or a mixture of pulp and cotton linters.

The base material of the combustible fumigant includes, for example, an exothermic agent such as a nitrate, a nitrite, a guanidine salt, potassium chlorate, nitrocellulose, ethylcellulose and wood powder, a pyrolytic stimulating agent such as an alkali metal salt, an alkaline earth metal salt, a dichromate and chromate, an oxygen source such as potassium nitrate, a combustion assistant such as melanin and wheat starch, a bulk filler such as diatomaceous earth and a binding agent such as synthetic glue.

The base material of the chemical fumigant includes, for example, an exothermic agent such as an alkali metal sulfide, polysulfide, hydrogensufide, hydrated salt and calcium oxide, a catalytic agent such as carbonaneous substance, iron carbide and activated clay, an organic foaming agent such as azodicarbonamide, benzenesulfonylhydrazide, N,N′-dinitrosopentamethylene-tetramine, polystyrene and polyurethane and a filler such as natural or synthetic fibers.

Examples of the base material of the volatile agent include thermoplastic resins, filter paper and Japanese paper.

The base material of the poisonous baits includes a bait component such as grain powder, vegetable oil, sugar and crystalline cellulose, an antioxidant such as dibutylhydroxytoluene and nordihydroguaiaretic acid, a substance for preventing erroneous eating such as red pepper powder, an attractant such as cheese flavor onion flavor and peanut oil.

The flowable formulations are usually prepared by finely dispersing the present compound at a ratio of 1 to 75 wt % in water containing a 0.5 to 15 wt % dispersing agent, a 0.1 to 10 wt % suspension assistant (for example, protective colloid or a compound giving thixotropy) and 0 to 10 wt % additives (for example, an antifoamer, a rust preventive agent, a stabilizer, a developing agent, a penetrating assistant, antifreezing agent, a bactericide, a fungicide).

The present compound may be dispersed in oil, in which the present compound is substantially insoluble, to form oil suspensions.

Examples of the protective colloid include gelatin, casein, gums, cellulose ethers and polyvinyl alcohol. The compound giving thixotropy may be bentonite, aluminum magnesium silicate, xanthan gum or polyacrylic acid.

The formulations thus obtained is used as prepared or diluted with water and may be used simultaneously with another insecticide, another acaricide, another nematicide, a repellent, a bactericide, a herbicide, a plant growth regulator, a synergist, a fertilizer or a soil conditioner under non-mixed conditions or pre-mixed conditions.

Compositions with soy methyl esters. In one embodiment, an active composition comprises, in combination, 2-undecanone and a soy methyl ester. The composition can be in the form of an emulsion. Suitable compositions include but are not limited to those described in A. Jones, Pest-combating compositions comprising soy methyl ester, US Patent Application Publication No. 2006/0127434 (Jun. 15, 2006) and A Jones, Pest control compositions, and methods and products utilizing same, PCT Application WO 2006/065886.

Soy methyl esters usefully employed in compositions of the present invention are readily commercially available, e.g., under the brand name “Enviro-Saver” from Columbus Foods Company (Chicago, Ill.), under the brand name “Ecoline Soya Methyl Esters” from Cortec Corporation (St. Paul, Minn.), and otherwise as fatty acid methyl ester from Cargill Industrial Oils & Lubricants (Minneapolis, Minn.), as methyl soyate from Cognis Corporation (Cincinnati, Ohio), and as soy methyl esters from Vertec BioSolvents, Inc. (Downers Grove, Ill.), Lambent Technologies Corporation (Gurnee, Ill.), soy-based fatty acid esters from Chemol Company, Inc. (Greensboro, N.C.), SoyGold 1000 from Ag Environmental Products (Omaha, Nebr.), and Steposol SB-D and Stepasol SB-W soy methyl esters from Stepan Company (Northfield, Ill.).I

In formulating the soy methyl ester in compositions as described herein, the soy methyl ester can be formulated as an emulsified base to which are added carrier, adjuvant and other ingredients of the composition. For example, the additional ingredients may include fillers, dispersants, water or other solvent medium or media, surfactants, suspension agents, sticking agents, stabilizers, preservatives, dyes, pigments, masking agents, emollients, excipients, post-application detection agents, and additional active ingredients. Such additional active ingredients may include, for example, additional pest-combating ingredients, such as repellents or cidal agents. In a preferred embodiment, the soy methyl ester emulsion may be formulated with an insect repellent ingredient such as 2-undecanone.

Thus a particularly advantageous composition in accordance with the present invention includes soy methyl ester in combination with 2-undecanone. Such composition has been found to provide superior repellency against mosquitoes and ticks. Due to the volatility of 2-undecanone, it is desirable to formulate the composition containing such ingredient with a sticking agent, so that the 2-undecanone in the composition persists at the point of application, to extend the duration of active repellency of the composition.

Compositions in accordance with the present invention may be formulated in any suitable manner appropriate to the ingredients involved. The soy methyl ester preferably is utilized as an emulsified base for the composition.

The soy methyl ester can be used at any suitable concentration in the compositions of the invention'. Preferably, the soy methyl ester has a concentration in the composition of from about 2% to about 15% by weight, based on the total weight of the composition. More preferably, the soy methyl ester has a composition concentration in a range of from about 2.4% to about 12% by weight, based on total weight of the composition. Most preferably, the soy methyl ester has a concentration in the composition in a range of from about 3 to about 10% by weight, based on total weight of the composition.

Compositions as described herein may be formulated for application or administration to any locus in which it is desired to repel pests against which the compositions of the invention are repellently effective. Such loci may contain or include apparel, furniture, personal accessories, plastic products, cloth products, camping equipment, automotive and vehicular interiors, and the like. For indoor or outdoor usage, the compositions of the invention may be formulated for broadcasting by misting systems or other distribution equipment (see, e.g., US Pat. Appln. 2006/0127434).

Termite compositions. Active compounds and compositions as described above can be combined with a termite attractant (including but not limited to those described in U.S. Pat. Nos. 7,169,403; 6,413,551; and 5,637,298), and/or with an additional termicidal agent or termite killing agent (including but not limited to those described in U.S. Pat. Nos. 7,211,270; 6,875,440; 6,858,653; 6,890,960; and 6,961,453) to provide compositions specifically tailored to killing termites.

Methods of contacting or applying. The active agents and compositions described above can be applied directly to insects in an effective insecticidal amount, or applied to a substrate, including animal (e.g., mammalian species such as cattle, horses, dogs, cats, etc) and plant (e.g., monocot and dicot crops and plants such as corn, wheat, tobacco, cotton, tomato, pine, soybean, canola, etc.) by any suitable technique, including but not limited to spraying, misting, dipping, etc.

Control of termites by any of a variety of techniques such as spraying, impregnating, painting or otherwise treating wood products or other susceptible building materials (e.g., plaster, some polymer materials and composites, etc.) with compounds or compositions of the invention; by fumigating soil adjacent such wood products or other susceptible building materials with compounds or compositions of the invention; by applying granules or bait granules comprising compounds or compositions of the invention to soil adjacent such wood products or other susceptible building materials, etc.

Building materials can be coated, impregnated or both with an active agent or composition as described above. Examples of such building materials include but are not limited to cellulosic building materials such as pine board, pine plank, pine posts, plywood, and composite chipboard.

Pests. Pests that can be killed by the methods, compositions, and active agents described herein include but are not limited to those insects, mites and ticks described in U.S. Pat. No. 6,048,892, as follows:

Hemiptera: Delphacidae (planthoppers) such as Laodelphax striatellus (small brown planthopper), Nilaparvata lugens (brown planthopper) and Sogatella furcifera (white-backed rice planthopper); Cicadelloidea (leafhoppers) such as Nephotettix cincticeps (green rice leafhopper), Nephotettix virescens (green rice leafhopper) and Recilia dorsalis; Aphidoidea (aphids); stink bugs such as Pentatomidae, Acanthosomatidae, Urostylidae, Dinidoridae, Coreidae and Alydidae; Aleyrodidae (whiteflies); Tingidae (lace bugs); Psyllidae (jumping plantlice); and so on;

Lepidoptera: Pyralidae such as Chilo suppressalis (rice stem borer), Cnaphalocrocis medinalis (rice leafroller) and Plodia interpunctella (Indian meal moth); Noctuidae such as Spodoptera litura (tobacco cutworm), Pseudaletia separata (rice armyworm), Mamestra brassicae (cabbage armyworm); Pieridae such as Pieris rapae crucivora (common cabbageworm); Tortricidae such as Adoxophyes spp.; Carposimidae; Lyonetiidae; Lymantriidae (tussock moths); Plusiinae; Agrotis spp. such as Agrotis segetum and Agrotis ipsilon (black cutworm); Heliotis spp.; Plutella xylostella (diamondback moth); Tinea pellionella (casemaking clothes moth); Tineola bisselliella (webbing clothes moth); and so on;

Diptera: Culex spp. such as Culex pipiens pallens (common mosquito) and Culex tritaeniorhynchus; Aedes spp. such as Aedes aegypti and Aedes albopictus; Anopheles spp. such as Anopheles sinensis; Chironomidae (midges); Muscidae such as Musca domestics (housefly), Muscina stabulans (false stablefly) and Fannia canicularis (little housefly); Calliphoridae; Sarcophagidae; Anthomyiidae such as Delia platura (seedcorn maggot) and Delia antiqua (onion maggot); Tephritidae (fluit flies); Drosophilidae; Psychodidae (moth flies); Simuliidae (black flies); Tabanidae; Stomoxyidae; Ceratopogonidae (biting midges); and so on;

Coleoptera (beetles): Diabrotica spp. (corn rootworms) such as Diabrotica virgifera (western corn rootworm) and Diabrotica undecimpunctata howardi (southern corn rootworm); Scarabaeidae such as Anomala cuprea and Anomala rufocuprea (soybeen beetle); Curculionidae such as Sitophilus zeamais (maize weevil) and Lissorhoptrus oryzophilus (ricewater weevil); Tenebrionidae (darkling beetles) such as Tenebrio molitor (yellow mealworm) and Tribolium castaneum (red flour beetle); Chrysomelidae such as Phyllotreta striolata (striped flea beetle) and Aulacophora femoralis (cucurbit leaf beetle); Anobiidae; Epilachna spp. such as Epilachna vigintioetopunctata (twentyeight-spotted ladybird); Lyctidae (powder post beetles); Bostrychidae (false powder post beetles); Cerambycidae; Paederus fuscipes (robe beetle); and so on;

Dictyoptera: Blattella germanica (German cockroach); Periplaneta fuliginosa (smokybrown cockroach); Periplaneta americana (American cockroach); Periplaneta brunnea (brown cockroach); Blatta orientalis (oriental cockroach); and so on;

Thysanoptera: Thrips palmi; Thrips hawaiiensis (flower thrips); thunderflies, thunderbugs, corn lice and other thrips and so on;

Hymenoptera: Formicidae (ants); Vespidae (hornets); Bethylidae; Tenthredinidae (sawflies) such as Athalis rosae ruficornis (cabbage sawfly); and so on;

Orthoptera: Gryllotalpidae (mole crickets); Acridadae (grasshoppers); and so on;

Siphonaptera: Ctenocephalides canis (dog flea); Ctenocephalides felis (cat flea); Pulex irritans; and so on;

Anoplura:

Pediculus humanus capitis; Pthirus pubis; and so on;

Isoptera: Reticulitermes speratus; Coptotermes formosanus; and so on;

Tetranychidae: Tetranychus cinnabarinus (carmine spider mite); Tetranychus urticae (two-spotted spider mite); Tetranychus kanzawai (Kanzawa spider mite); Panonychus citri (citrus red mite); Panonychus ulmi (European red mite); and so on;

House-dust mites:

Acaridae; Dermatophagoidinae; Pyroglyphinae; Cheyletidae; Macronyssidae such as Ornithonyssus spp.; and so on;

Ticks: Ixodidae such as Boophilus microplus; and so on.

Termites, including drywood, subterranean termites (or ground termites, including Eastern, Western, and Desert termites), and Formosan termites (sometimes referred to as Formosan subterranean termites or the “super termite”).

The present invention is explained in greater detail in the following non-limiting Examples.

### Example 1

### Phytotoxicity of BioUD 4% (2-Undecanone) on Beans

Objective: To determine the BioUD 4% (2-undecanone) concentrations, formulated with vegetable oils, that are safe to apply to bean plants, Phaseolus vulgaris.

Materials and Methods: One-week old bean plants (Phaseolus vulgaris) were used in this trial. The seeds were previously planted into 4-inch plastic pots with Metro Mix 200 growing media on May 10, 2007 and placed under greenhouse conditions (Method Rd. Greenhouses, NCSU). The treatments were applied using a manual sprayer until runoff. The treatments were: 1) no treatment, 2) deionized water, 3) control (deionized water+lecithin), 4) 100 ppm, 5) 200 ppm, 6) 400 ppm, 7) 800 ppm and 8) 1600 ppm of 2-undecanone. All BioUD 4% (2-undecanone) dilutions were made into 1% lecithin solution. Each treatment was replicated five times.

After 24 and 48 hrs, plants were monitored to observe if the treatments cause any visible damage. Height measure was taken the day of the treatment application (May 17, 2007) and after one week (May 24, 2007), to determine the effect of 2-undecanone in plant growth in cm. Also, one week after treatment application the plants were harvested and taken into the laboratory (Deastyne Entomology Building, NCSU) to measure the fresh weight in grams. Data was analyzed with an analysis of variance (ANOVA) in the program Excel, Microsoft®.

Results: After 24 hrs, damage (burned leaf areas) was observed in 3 out of 5 plants in the 400 ppm 2-undecanone treatment, and all plants treated with 800 and 1600 ppm 2-undecanone. The damage was more severe at higher concentrations. After 48 hrs of treatment application, 3 out of 5 plants in the 200 ppm presented some slight damage (few spots), and all plants treated with 400, 800 and 1600 ppm 2-undecanone showed damage, with more severe injure at higher concentrations (data not shown).

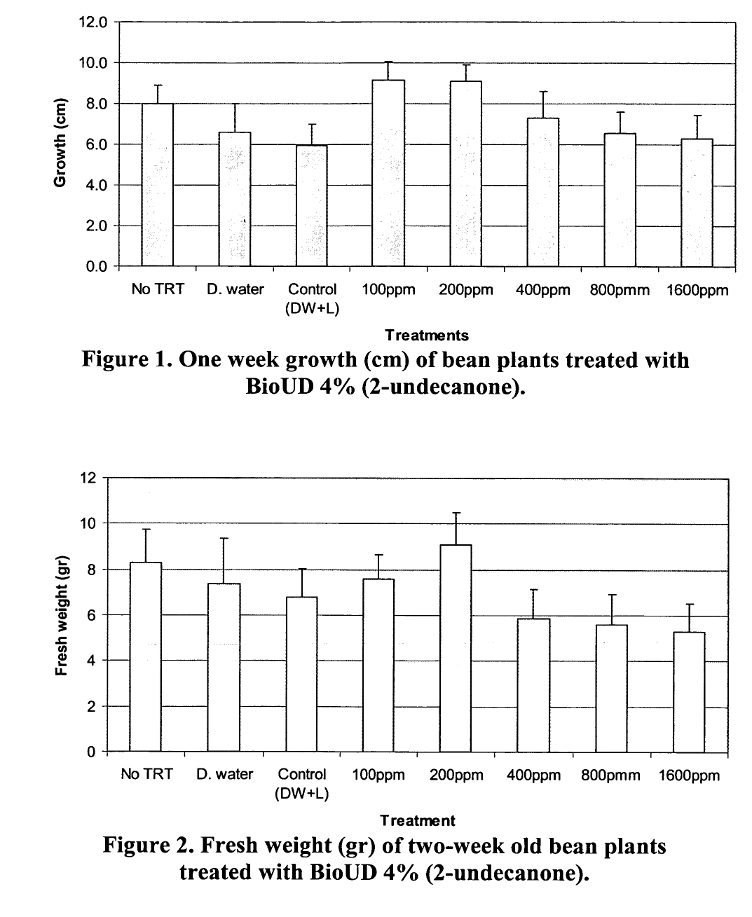

There was no significant effect of BioUD 4% (2-undecanone) evaluated concentrations on the growth (in cm) of bean plants (F=1.3240, P=0.2713) (FIG. 1). Moreover, there was no significant effect (F=0.9378, P=0.4916) on the fresh weight (in gr) of two-week old bean plants treated with various concentrations of BioUD 4% (2-undecanone) (FIG. 2).

Conclusion: It is not preferred to use of BioUD 4% (2-undecanone) at a concentration of 200 ppm 2-undecanone or higher on one-week old bean plants without further formulation (as shown below).

### Example 2

### Phytotoxicity of BioUD 4%

### (2-Undecanone) Formulated with Silicone on Beans

Objective: To determine the BioUD 4% (2-undecanone) concentrations, formulated with silicone, that are safe to apply to bean plants, Phaseolus vulgaris.

Materials and Methods: One-week old bean plants (Phaseolus vulgaris) were used in this trial. The seeds were previously planted into 4-inch plastic pots with Metro Mix 200 growing media on Jun. 6, 2007 and placed under greenhouse conditions (Method Rd. Greenhouses, NCSU). The treatments were applied using a manual sprayer until runoff. The treatments were: 1) no treatment, 2) deionized water, 3) 100 ppm, 4) 200 ppm, 5) 400 ppm, 6) 800 ppm and 7) 1600 ppm of 2-undecanone (BioUD 4%), formulated with silicone. Each treatment was replicated five times.

After 24 and 48 hrs, plants were monitored to observe if the treatments cause any visible damage. Height measure was taken the day of the treatment application and after one week, to determine the effect of 2-undecanone in plant growth in cm. Also, one week after treatment application the plants were harvested and taken into the laboratory to measure the fresh weight in grams. Data was analyzed with an analysis of variance (ANOVA) in the program Excel, Microsoft®.

Results: After 24 and 48 hrs no damage (burned leaf areas) was observed in any of the treatments.

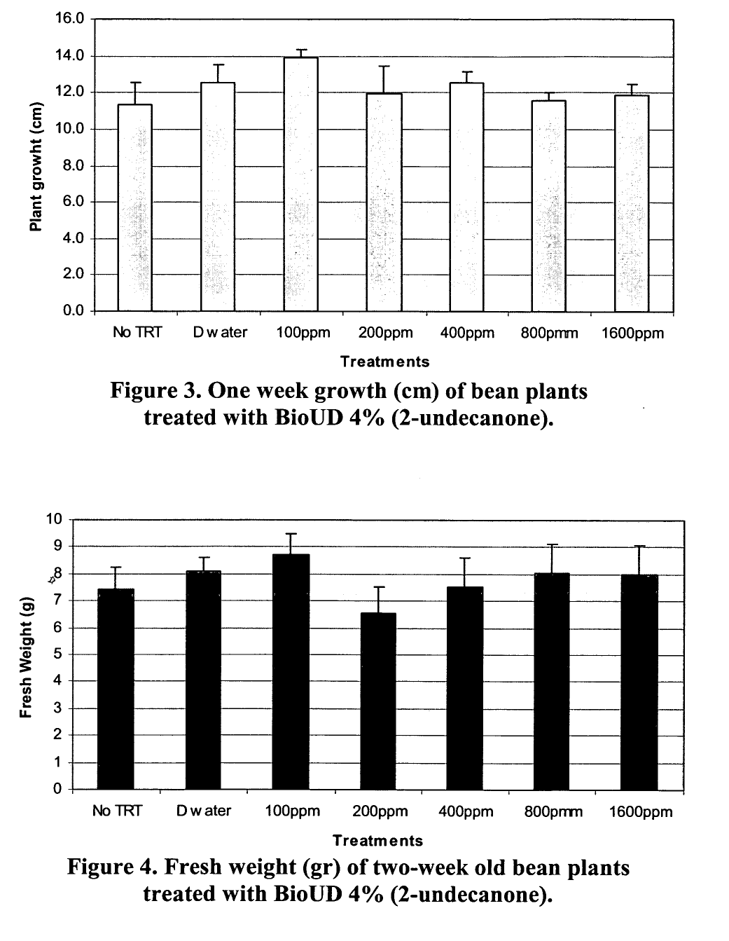

There was no significant effect of BioUD 4% (2-undecanone) evaluated concentrations on the growth (in cm) of bean plants (F=0.8662, P=0.5316) (FIG. 3). Moreover, there was no significant effect (F=0.5422, P=0.7716) on the fresh weight (in gr) of two-week old bean plants treated with various concentrations of BioUD 4% (2-undecanone) (FIG. 4).

Conclusion: It is appears preferable to apply 2-undecanone (BioUD 4%) formulated with silicone, up to 4% solution.

### Example 3

### Lethal Effect Evaluation of BioUD 4%

### (2-Undecanone) Formulated with Silicone on Tobacco Aphids

Objective: To estimate the lethal effect of BioUD 4% (2-undecanone) formulated with silicone, on tobacco aphids, Myzus persicae.

Materials and Methods: Slide dip assay as described by Busvine (Busvine, J. R. 1971. A critical review of the techniques for testing insecticides. Commonwealth Agricultural Bureaux, London. 345 pp.) was used to estimate the lethal effect of 2-undecanone, commercialized as BioUD 4% formulated with silicone. Adult tobacco aphids from a colony reared under greenhouse conditions on tobacco plants were used in this assay. Twenty tobacco aphids were placed dorsal side down over double sided tape on a microscope slide. The slides were dipped for 5 sec. on different concentrations of 2-undecanone and then were allowed to dry for 30 min. under laboratory conditions. The treatments were 0 ppm (deionized water), 25 ppm, 100 ppm and 400 ppm of 2-undecanone. Afterward, slides were placed inside a plastic container in a growth chamber at 27° C. and 95% relative humidity. After 24 hrs, slides were observed under a dissecting scope to determine the mortality of tobacco aphids.

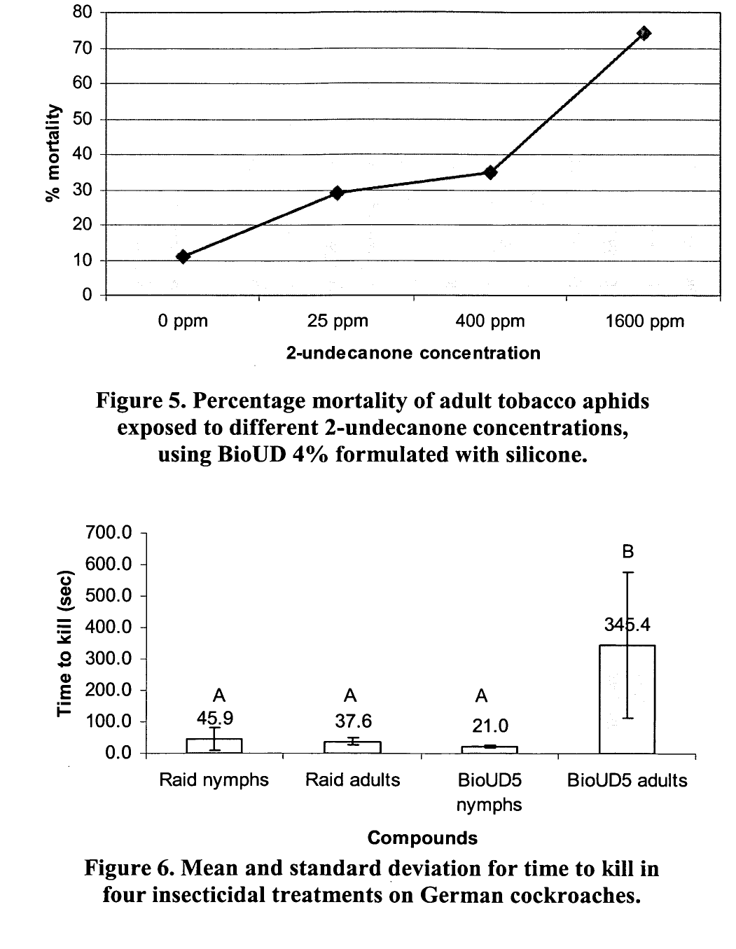

Results: After 24 hrs, the percentage mortality of adult tobacco aphids was 11, 29, 35 and 74% for 0, 25, 400 and 1600 ppm respectively (FIG. 5).

### Example 4

### Toxicity on German Cockroaches

Toxicity tests were conducted on German cockroaches, Blattella germanica, with several established insecticides purchased from the store and BioUD5 obtained from Homs, LLC. The insecticidal dose was pipetted onto the back (thorax and abdomen, but also wings in case of adults) of each individual cockroach. Data are given in Table 1 and FIG. 6.

TABLE 1
Comparison of insecticidal compounds
(¹d = days, ²n.d. = not determinable).

| | | | | adults: 10 μL | | | | | |
|---|---|---|---|---|---|---|---|---|---|
| | 7-10 day old | | | | | | | | Ortho |
| | nymphs: 5 μL | | | | | | | Hot | Home |
| | Raid | BioUD5 | Surefire | Raid | BioUD5 | Surefire | Sevin | Shot | Defense |
| seconds | 15 | 20 | 88 | 47 | 240 | 117 | >3 d¹ | >600 | >1 d |
| until | 109 | 19 | >300 | 25 | 600 | 94 | >3 d | >600 | >1 d |
| death | 90 | 17 | >300 | 53 | 279 | >600 | | | >1 d |
| | 26 | 21 | 92 | 32 | 51 | 95 | | | |
| | 21 | 28 | >300 | 31 | 557 | >600 | | | |
| | 35 | | | | | 167 | | | |
| | 18 | | | | | >600 | | | |
| | 53 | | | | | 75 | | | |
| mean | 45.9 | 21.0 | n.d.² | 37.6 | 345.4 | n.d. | n.d. | n.d. | n.d. |
| stdev | 35.5 | 4.2 | n.d. | 11.8 | 230.1 | n.d. | n.d. | n.d. | n.d. |

Table 1 clearly shows that only Raid and BioUD5 give reliable results for quick cockroach extermination. Sevin did not kill adult cockroaches at all, even after 3 days. FIG. 6 demonstrates that BioUD5 is comparable to Raid for nymphal kills, but somewhat slower for adults.

### Example 5

### Test for Insecticidal Action of BioUD, 10% a.i., 2-Undecanone, and Raid

Material and Methods: Ten μL of either BioUD 10, pure 2-Undecanone, or Raid were separately applied to the backs (thorax and wings) of adult German cockroaches, Blattella germanica. Insects were separately placed into FLUON®-treated diet cups (Vol.=30 mL, lower diam.=3 cm, height=4 cm) to prevent escape of treated specimens.

Results and Conclusions: Table 2 gives the results for time-to-death of male and female cockroaches treated with 10 μL of either BioUD10, Undecanone, or Raid. There seems to be a large difference for insecticidal activity of BioUD10 between males and females, but not for Undecanone itself. However, numbers of males are still low. These differences may be partially due to mass differences in the two sexes. Another possibility is that sometimes cockroaches may not be “hit” completely by the formulation. Pure Undecanone appears to kill cockroaches 2× faster then the formulated product, regardless of male of female (Table 2). Both seem to work better than a leading commercial brand, Raid. Because of the large variation in the data, differences are not statistically significant.

TABLE 2
Time-to-death for adult male and female B. germanica after
treatment with 10 μL of either BioUD10, 2-Undecanone, or Raid.

| | Sex | Time-to-death | mean | st. dev. | mean | st. dev. |
|---|---|---|---|---|---|---|
| BioUD10 | ♀ | 30 min | 20 min | 10 min 45 sec | 14 min 23 sec | 12 min |
| | ♀ | 31 min 39 sec | | | | |
| | ♀ | 14 min 35 sec | | | | |
| | ♀ | 7 min 22 sec | | | | |
| | ♀ | 26 min 48 sec | | | | |
| | ♀ | 9 min 39 sec | | | | |
| | ♂ | 1 min 25 sec | 3 min 9 sec | 1 min 42 sec | | |
| | ♂ | 4 min 48 sec | | | | |
| | ♂ | 3 min 15 sec | | | | |
| 2- | ♀ | 47 sec | 7 min 56 sec | 9 min 39 sec | 7 min 48 sec | 8 min 45 sec |
| Undecanone | ♀ | 4 min 38 sec | | | | |
| | ♀ | 20 min 28 sec | | | | |
| | ♀ | 46 sec | | | | |
| | ♀ | 20 min | | | | |
| | ♀ | 57 sec | | | | |
| | ♂ | 13 min 22 sec | 7 min 24 sec | 8 min 26 sec | | |
| | ♂ | 1 min 26 sec | | | | |
| Raid | ♀ | 30 min | 16 min 55 sec | 15 min 7 sec | 19 min 32 sec | 14 min 21 sec |
| | ♀ | 30 min | | | | |
| | ♀ | 4 min 40 sec | | | | |
| | ♀ | 3 min | | | | |
| | ♂ | 30 min | 30 min | | | |

### Example 6

### German Cockroaches

### Various Formulations

BioUD in water

Test Method. Laboratory testing was conducted to determine the efficacy of BioUD (active ingredient: 2-Undecanone [Methyl-Nonyl-Ketone, C₁₁H₂₂O]) at several concentrations against the German cockroach, Blattella germanica (L.). All research was performed by Dr. Christof Stumpf in the Department of Entomology at North Carolina State University in Raleigh, N.C. Temperature and RH in the laboratory were 22.5±0.4° C. and 25.0±0.5%, respectively. Tests were performed in Del-Pak® polypropylene plastic cups (Reynolds Food Packaging, Alcoa Grottoes Plastics Plant, Grottoes, Va.), with a bottom diameter of 82 mm and a height of 80 mm. The bottom of a cup was divided into two parts with a marker pen. The sides of a cup were covered with Fluon®AD1 (AGC Chemicals Americas, Inc. Bayonne, N.J.) using KimWipes® (Kimberley-Clark Corporation, Roswell, Ga.) in order to prevent escaping of insects.

BioUD available as a hydrateable suspension containing 4% (Vol.) Undecanone was obtained from Homs, LLC, Clayton, N.C., and further diluted in distilled and autoclaved H₂O resulting in the following percentages of Undecanone: 4, 1, 0.1, 0.01, 0.001, 0.0001, and 0.00001. One of the two marked halves of each bottom of a cup was treated with 5 μL of the water suspension which was evenly distributed using a small plastic brush leading to the following doses of Undecanone on half of the surface of the bottom of the cup: 7.57, 0.89, 0.19, 0.019, 0.0019, 0.00019, and 0.000019 nL Undecanone/cm², for each of the previously described suspensions of BioUD, respectively.

For the experiment, five next-to-last instar cockroaches were placed into each cup, and their positions (located in treated or untreated area) were recorded after 5, 10, 15, 30, 60, 90, and 120 min. The experiment was replicated three times with different cockroaches in separate cups. A random distribution in a cup assumes a 50% chance of each cockroach to be in either half of the cup, while cockroaches repelled by BioUD will be found in the untreated half. Percent repellency is therefore calculated as number of cockroaches found in the untreated half of a cup divided by the total number of cockroaches (5).

Results and discussion. For each dose, there was a slight increase in repellency over time (Table 3). Therefore, results for 2 h are used to discuss results. At the highest doses, 7.57 and 1.89 nL Undecanone/cm², 100% repellency was achieved after 2 h (, Table 3). A dose of 0.19 nL Undecanone/cm² still gave 0.93±0.07 (SEM) % repellency after 2 h, while other doses were not different from 50% according to the SEMs (Table 3). However, for 0.0019 nL Undecanone/cm², there was 80% repellency without any variation in all 3 cups for 2 h. This points to the need for more replicates (altogether 15 cockroaches were used per dose in 3 cups) for a more thorough analysis in later experiments.

Conclusions. Using a volume of 5 μL BioUD diluted in H₂O, a dose of 1.89 nL Undecanone/cm² surface area gave complete repellency against next-to-last instar B. germanica. Further tests should include larger volumes of BioUD as well as a larger number of replicates. The goal is to use the same procedure to test BioUD against cockroaches on commercially available kitchen counter surfaces (HI-MACS® Terra Quartz [LG Chem], CORIAN® Silt (C) [Du Pont]). For this purpose, the bottom of the aforementioned Fluon-treated plastic cups will be removed and cups glued to a kitchen counter surface. The surface covered by a cup will then again be divided into two halves with a marker pen, and one of the halves will be treated as previously described. The experiment will be conducted in the same manner as described.

TABLE 3
Percent Repellency (±SEM) of BioUD in H₂O against 30 day old cockroach nymphs
(Blattella germanica), n = 3 replicates, with 5 cockroaches/cup, walls covered with Fluon.

| | | minutes | | | | | | |
|---|---|---|---|---|---|---|---|---|
| | | 5 | 10 | 15 | 30 | 60 | 90 | 120 |
| nL | 0 | 0.87 ± 0.13 | 0.87 ± 0.07 | 0.87 ± 0.13 | 0.73 ± 0.27 | 0.67 ± 0.33 | 0.67 ± 0.33 | 0.67 ± 0.33 |
| Undecanone/cm² | 0.000019 | 0.53 ± 0.24 | 0.67 ± 0.07 | 0.47 ± 0.18 | 0.67 ± 0.18 | 0.40 ± 0.31 | 0.33 ± 0.18 | 0.47 ± 0.29 |
| | 0.00019 | 0.33 ± 0.07 | 0.53 ± 0.13 | 0.47 ± 0.27 | 0.47 ± 0.13 | 0.40 ± 0.23 | 0.40 ± 0.23 | 0.47 ± 0.29 |
| | 0.0019 | 0.67 ± 0.18 | 0.60 ± 0.20 | 0.53 ± 0.07 | 0.67 ± 0.18 | 0.80 ± 0.20 | 0.67 ± 0.18 | 0.80 ± 0.00 |
| | 0.019 | 0.73 ± 0.13 | 0.53 ± 0.29 | 0.80 ± 0.12 | 0.67 ± 0.33 | 0.73 ± 0.27 | 0.73 ± 0.27 | 0.60 ± 0.31 |
| | 0.19 | 0.80 ± 0.12 | 0.73 ± 0.18 | 0.67 ± 0.13 | 0.87 ± 0.13 | 0.93 ± 0.07 | 0.87 ± 0.13 | 0.93 ± 0.07 |
| | 1.89 | 1.00 ± 0.00 | 1.00 ± 0.00 | 0.80 ± 0.12 | 1.00 ± 0.00 | 0.87 ± 0.07 | 0.93 ± 0.07 | 1.00 ± 0.00 |
| | 7.57 | 1.00 ± 0.00 | 0.93 ± 0.07 | 0.93 ± 0.07 | 1.00 ± 0.00 | 1.00 ± 0.00 | 1.00 ± 0.00 | 1.00 ± 0.00 |

### Soy Methyl Ester

Test Method. Testing for percent repellency of soy methyl ester (Biodiesel) against B. germanica followed the protocol for BioUD in H₂O with some modifications: only undiluted soy methyl ester was used for all tests without any added BioUD (5 μL, 0.19 μL/cm²), cockroaches of three different age classes were used for the experiment (10 days, 20 days, 30 days old, when reared in an incubator at 27.0±1.0° C., 65.0±0.5% RH, 14:10 L:D), each age class experiment was replicated 4 times, and additional time points for monitoring the position of cockroaches were added at 180 and 240 min. The effect of deaths that occurred during the experiment were taken into consideration during data analysis.

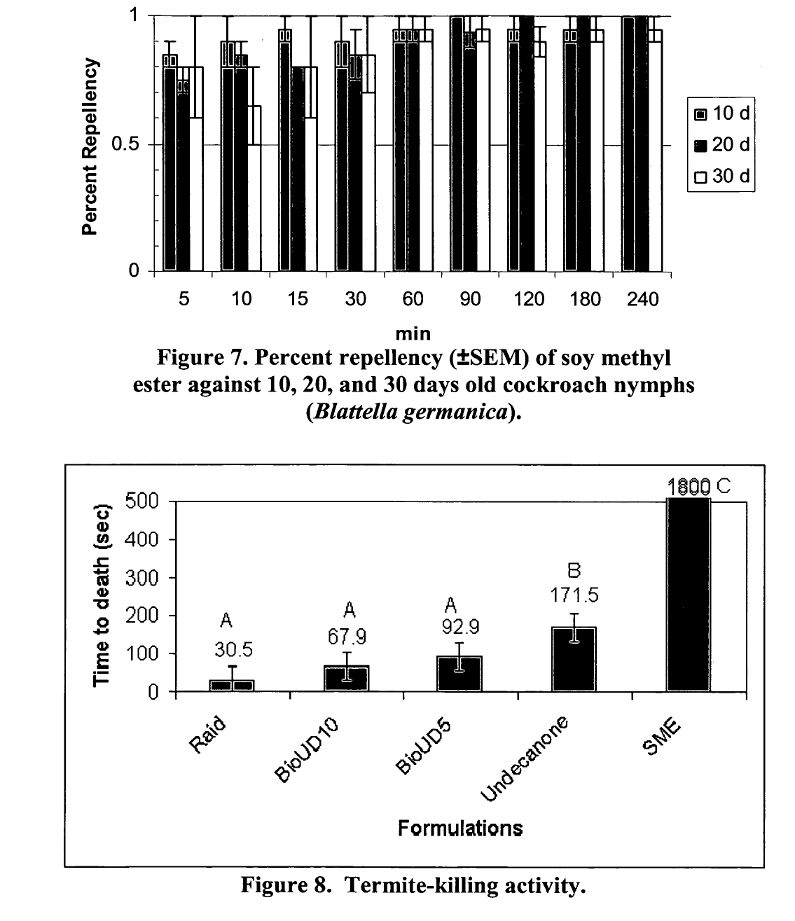

Results and discussion. At each time point in the experiment, all three ages groups of the German cockroach were repelled more than 50% by undiluted soy methyl ester at a dose of 0.19 μL/cm² (FIG. 7). Repellency reached 100% for the 10 d old cockroaches at 90 min and again at 240 min and stayed at 100% for the 20 d old cockroaches at 120 min, while it remained constant at 95% at 180 and 240 min for the 30 d old cockroaches. In each age group, one death occurred during the course of the experiment. Biodiesel by itself appears to be an effective repellent against cockroaches. However, 100% repellency could not be achieved for the 30 d age group. Conclusions. The effects of soy methyl ester on cockroaches will be studied in experiments on kitchen countertop material similar to the previously described experiments with H₂O-diluted BioUD. However, these effects will be studied together with the effects of BioUD diluted in Biodiesel.

### BioUD in Soy Methyl Ester

Test Method. The method employed for testing BioUD in Biodiesel was somewhat different from the previously described methods, because no Fluon was available for the tests. Therefore, vaseline was used to prevent escape of cockroaches (9 days old). The bottom of a cup was prepared the same way than previously described, but this time also the walls were treated up to a height of 5 cm, and the upper 3 cm of a cup were smeared with vaseline. This treatment appeared necessary, because on the edges cockroaches may be able to right themselves and escape the treatment effect, which is not possible with Fluon. The total surface area was therefore 90.8 cm², and a total of 15 μL BioUD diluted in soy methyl ester was applied, compared to 5 μL in the previous two experiments. During the experiment, a tray was placed over the cups, and the cups were also covered with black tarp. Due to the large number of cockroach deaths the experiment was not replicated.

Results and discussion. At the highest dose of Undecanone, insects were knocked down and could not move any more (Table 4). In all cases, a very high percentage of cockroaches chose the untreated area over the treated one, and no dose effect was recorded. These results are in line with the results from the soy methyl ester experiment (FIG. 7). However, nothing can be said about the effect of Undecanone by itself, because soy methyl ester also has a repellent effect. The experiment had to be terminated after 60 min because of the high death toll that the soy methyl ester/Undecanone combination had on the cockroaches (Table 4). The tray covering the cups was not airtight and allowed vapor escape. However, it is still possible that presence of the tray interfered with the outcome of the experiment. The black tarp on top of the tray created too much of a disturbance for the cockroaches during removal for studying cockroach positioning. This resulted in the canceling of the 30 min measurement.

TABLE 4
Number of 9d old cockroach nymphs (Blattella germanica)
on untreated control surface¹/surface treated with BioUD
in soy methyl ester², with 5 cockroaches/cup, top
3 cm of walls covered with vaseline.

| | | minutes | | | |
|---|---|---|---|---|---|
| | | 5 | 10 | 15 | 60 |
| nL Undecanone/cm² | 0.000017 | 4¹/1² | 4/1 | 4/1 | 2 dead |
| | 0.00017 | 4/1 | 4/1 | 4/1 | 4 dead |
| | 0.0017 | 4/1 | 3/2 | 3/2 | 4 dead |
| | 0.017 | 3/2 | 3/2 | 2/3 | 2 dead |
| | 0.17 | 5/0 | 5/0 | 5/0 | 1 dead |
| | 1.65 | 4/1 | 4/1 | 4/1 | 4 dead |

| | | |
|---|---|---|
| 8.26 | insects knocked | 3 dead |
| | down - flat | |
| | on back | |

Conclusions. Clearly, the combination of soy methyl ester and BioUD has a strong effect on cockroaches. Further experiments with the same methodology are planned on kitchen counter surfaces. We are also planning the use of larger cups for a bigger surface area test. The use of vaseline to prevent escape attempts will be discontinued, and only Fluon will be used for this purpose. Also, to minimize effect of vapors and possible cross-effects from neighboring cups, trays will not be placed over the cups any more. Cockroaches are very sensitive to sudden movements and changes in light intensity. These series of experiments showed that it is better to keep experimental cups under laboratory lighting and avoidance of human activity in the vicinity than to cover them up and expose the cockroaches to sudden visual changes.

### Example 7

### Killing Activity in Termites

The activity of the present invention in killing termites (specifically, the Eastern subterranean termite, Reticulitermes flavipes) is demonstrated further below in Table 5 below and in FIG. 8.

TABLE 5
pipet compound onto back (thorax, but also abdomen)
adults: 1 μL

| formulation | caste | Time-to-death (sec) | mean | stderr | | |
|---|---|---|---|---|---|---|
| Raid | w | 15 | 30.5 | 37A | | |
| Raid | w | 27 | | | | |
| Raid | w | 28 | | | | |
| Raid | s | 34 | | | | |
| Raid | w | 38 | | | | |
| Undecanone | w | 157 | 171.5 | 37B | | |
| Undecanone | w | 389 | | | | |
| Undecanone | w | 68 | | | | |
| Undecanone | w | 174 | | | | |
| Undecanone | s | 146 | | | | |
| BioUD10 | w | 68 | 67.9 | 37A | | |
| BioUD10 | w | 78 | | | | |
| BioUD10 | w | 72 | | | | |
| BioUD10 | w | 49 | | | | |
| BioUD10 | s | 69 | | | | |
| BioUD5 | w | 65 | 92.9 | 37A | | |
| BioUD5 | w | 58 | | | | |
| BioUD5 | w | 59 | | | | |
| BioUD5 | w | 85 | | | | |
| BioUD5 | s | 119 | | | | |
| SME | s | 1800 | 1800 | 40.5C | | |
| SME | w | 1800 | | | | |
| SME | w | 1800 | | | | |
| H2O | w | alive after 3 h | Raid | | 30.5 | 37A |
| H2O | w | alive after 3 h | BioUD10 | | 67.9 | 37A |
| H2O | w | alive after 3 h | BioUD5 | | 92.9 | 37A |
| H2O | w | alive after 3 h | Undecanone | | 171.5 | 37B |
| | | | SME | | 1800 | 40.5C |

### Example 8

### Uses, Applications, and Methods

In summary, the present invention provides, among other things, the use of undecanone (particularly 2-undecanone) as an active ingredient and (in some embodiments) formulated with a soy methyl ester as described herein, for the control as a toxicant of insects and acari. Such formulated undecanone is sometimes referenced as BioUD herein and can include modified plant oils and/or silicone additives as well as other components depending on the application used.

BioUD as a spray can be directly applied to insects or to plants, textiles and other substrates and its delivery to insects in candles, sandalwood sticks and other similar methods which will be apparent to those skilled in the art from the instant disclosure.

BioUD can be used for the control of a wide variety of pests in both home and commercial settings and as a possible replacement for the fumigant, methyl bromide.

Thus some examples of the practical uses of BioUD to control insects and acari by killing include but are not limited to the following:

(1) use by fogging and in misting systems to control mosquito populations, to control pests in home gardens, to control pests in green house commercial production facilities and to control pests like flies in commercial operations where food is prepared and sold;

(2) use in textiles to control bed bugs, lice, ticks and fleas in the hotel industry;

(3) use as a spray to control crawling insects including cockroaches and ants in and around the home and commercial places;

(4) use as a spray to kill wasps and wasp nests;

(5) use as a spray on counter tops where food is prepared for the control of crawling insects like cockroaches and ants;

(6) use as a replacement for methyl bromide for all applications that have used methyl bromide for pest control now and in the past (methyl bromide has been banned today except for special exemptions).

The foregoing is illustrative of the present invention, and is not to be construed as limiting thereof. The invention is defined by the following claims, with equivalents of the claims to be included therein.

1. A method of killing an arthropod pest, comprising contacting 2-undecanone to said pests in an amount effective to kill said pest.

2. The method of claim 1, wherein said contacting step is carried out by applying said 2-undecanone to a plant in an amount substantially non-toxic to said plant.

3. The method of claim 2, wherein said contacting step is carried out by applying said 2-undecanone as a composition comprising said 2-undecanone in combination with a soy methyl ester.

4. The method of claim 3, wherein said composition is an emulsion.

5. The method of claim 1, wherein said pest is selected from the group consisting of mites, ticks, aphids, mosquitoes, roaches, ants, termites, and thrips.

6. The method of claim 1, wherein said pest is a termite.

7. The method of claim 6, wherein said termite is selected from the group consisting of drywood, subterranean, and Formosan termites.

8. The method of claim 1, wherein said pest is an ant.

9. The method of claim 1, wherein said pest is a tick.

10. The method of claim 1, wherein said pest is a mosquito.

11. The method of claim 1, wherein said pest is a roach.

12. A method of killing an arthropod pest, comprising contacting 2-undecanone to said pests in an amount effective to kill said pest;
wherein said contacting step is carried out by applying said 2-undecanone as a composition comprising said 2-undecanone in combination with a soy methyl ester.

13. The method of claim 12, wherein said composition is an emulsion.

14. The method of claim 12, wherein said pest is selected from the group consisting of mites, ticks, aphids, mosquitoes, roaches, ants, termites, and thrips.

15. The method of claim 12, wherein said pest is a termite.

16. The method of claim 15, wherein said termite is selected from the group consisting of drywood, subterranean, and Formosan termites.

17. The method of claim 12, wherein said pest is an ant.

18. The method of claim 12, wherein said pest is a tick.

19. The method of claim 12, wherein said pest is a mosquito.

20. The method of claim 12, wherein said pest is a roach.

21. A composition comprising, in combination:
(a) 2-undecanone; and
(b) at least one additional active ingredient selected from the group consisting of termite attractants, termicidal compounds, and combinations thereof.

22. The composition of claim 21, further comprising soy methyl ester.

23. A building material impregnated with a composition comprising 2-undecanone.

24. The building material of claim 23, said composition further comprising soy methyl ester.

25. The building material of claim 23, wherein said building material is a cellulosic building material.

26. The building material of claim 23, wherein said building material is selected from the group consisting of pine board, a pine plank, pine posts, plywood, and composite chipboard.

27. (canceled)
